(19) United States
(12) Patent Application Publication
(10) Pub. No.: US 2008/0267047 A1
(43) Pub. Date: Oct. 30, 2008

(54) Secure optical data card system

(75) Inventors: Francis K. King, San Jose, CA (US); Jeffrey F. Liu, San Jose, CA (US)

Correspondence Address: Bo-In Lin, 13445 Mandoli Drive, Los Altos Hills, CA, 94022, US

(73) Assignee: DCARD, INC.

(21) Appl. No.: 11/796,095

(22) Filed: Apr. 26, 2007

(51) Int. Cl. G11B 7/24

(52) U.S. Cl. 369/275.1

(57) ABSTRACT

A method of producing data storage card for storage of machine-readable information includes an optical memory area subjected to optical information recording and reproduction, comprising, a card-like card body, an optical recording portion provided on the card body. A method of combining a file access system with a write once optical data card produces a secure portable database system.

### BACKGROUND OF THE INVENTION

1. Field of the Invention

This invention relates generally the method for manufacturing a write once optical memory storage card with a conventional credit card size and the method of securely storing/retrieving non-updatable data in sequential writing and random reading manner in addition to adding data in multiple sequential writing process sessions to such write once optical data card. More particularly, this invention is related to an improve method for producing optical data card and multiple files writing/reading system to form a secure optical data card system suitable for local portable database applications such as portable medical record system.

2. Description of the Prior Art

Many technologies have been disclosed for data storage and access on different kinds of data storage cards. However, these technologies do not provide an effective storage card for applications that require securely protection of the data written to the card while allowing for flexibly adding new data onto the card. For example, a data storage card that is provided to store medical data therein must provide secure data protection to prevent medical data records stored in the card being altered or overwritten. Meanwhile, the medical data storage card must allow for adding new data onto the card when new medical data records are made available. As most of the data storage cards disclosed by patented inventions are data cards provided for large storage capacity that are used for storing great amount of data, such data cards would not satisfy the requirements of securely protecting the stored data while allowing flexible adding data to the card in order to satisfy the requirements for such applications.

Many kinds of data storage cards have been disclosed. The disclosures include U.S. Pat. No. 4,868,383 by Opheij et. al, entitled “optical card with electronic chips”, U.S. Pat. No. 4,611,314 by Ogata et al. issued on Sep. 9, 1986 discussed a defect and data buffer management method of an optical disk. Further disclosures have been made in U.S. Pat. No. 4,682,318 by Busby issued on Jul. 21, 1987 that discusses multiple-zone methods with a temporary location for intermediate data. U.S. Pat. No. 4,677,606 by Ogata et al. that is issued on Jun. 30, 1987 includes disclosures of a multiple zones and blocks with pre-determined address assignment. U.S. Pat. No. 5,111,444 by Fukushima et al. that is issued on May 5, 1992 includes disclosures of a defect management of multiple zones. In U.S. Pat. No. 4,775,969, issued on Oct. 4, 1988, Osterlund discussed the emulation of a tape device with optical disk. The disclosures of these optical data storage cards such as CDR, CDRW, DVDR, or DVDRW are designed with large storage capacity for storing a very large amount of data. These methods do not provide an effective way to produce a secure optical data card with random file accessing system suitable for local portable database such as medical record applications.

The technologies as that commonly implemented in conventional Direct-Access information-recording and reproducing apparatuses, particularly those applied to “write-once” medium, cannot be conveniently applied to the optical data tracks supported on a card-shaped medium for recording data related to personal information such personal photo, biometric data and/or medical records, etc. Specifically, in a write-once optical disk, the recorded information cannot be rewritten; the contents stored in a file-allocation table (FAT) cannot be updated. The described file management technique is not valid and a rewritable optical disk does not have this type of problem. With its inherent very large capacity property, optical disk such as CDR, CDRW, DVDR, or DVDRW can use a multiple session method. This multiple session method allows a write-once optical disk to update information by creating a new session area and discarding the earlier sessions. Each session area has its own lead-in, data, and lead-out areas. The lead-in area has table of contents information and lead-out area indicates the end of data and end of this particular session information. The data area can use either 1988 ISO 9660 or 1995 OSTA Universal Data Format file management method. Comparatively, an optical write-once data card does not have the tremendous capacity provided by CDR, CDRW, DVDR, or DVDRW. The capacity of an optical card is not even enough to contain a conventional CDR or CDRW lead-in area. A write once data card is therefore limited with options to update or correct data written on the cards. Even a rewritable data card capacity may not be enough for the conventional lead-in and lead out format requirement. Such limitations may unduly increases the operation costs and causes great deal of difficulties if a requirement for data update or error correction arises.

The file structure in a recording medium contains significant information related to the file structure and status of these files to allow a data access device to efficiently access the data stored in different data areas. Specifically, Direct-Access information-recording and reproducing apparatus such as a magnetic disk and floppy disk, the file management including the defective sector management, a directory area for recording management information and a data area for recording file data are formed on the disk. A file allocation table (FAT) area is also formed in the disk to record an FAT for controlling the status of the data area. In such a disk, a defective may occur due to flaws, contamination or deterioration of the recording material, an identification flag is recorded in the FAT entry corresponding to such a defect. When a disk is formatted to initialize FAT entries, an unused flag meaning that unused areas are recorded in FAT entries in addition to the defect area entries. When recording a new file, FAT entries are updated to reflect the new usage of the area. In this operation, FAT entries having the defect flag are skipped so that defective area will not be used in recording the new file. After the data of the new file are recorded in unused area, the FAT is updated by rewriting the information, which describes the new status.

For optical disk configurations, U.S. Pat. No. 4,611,314 Ogata et al. Sep. 9, 1986 discussed a defect and data buffer management method of an optical disk, U.S. Pat. No. 4,682,318 Busby Jul. 21, 1987 discusses a multiple-zone methods with a temporary location for intermediate data, U.S. Pat. No. 4,677,606 Ogata et al. Jun. 30, 1987 discussed a multiple zones and blocks with pre-determined address assignment. U.S. Pat. No. 5,111,444 Fukushima et al. May 5, 1992 discussed a defect management of multiple zones. In U.S. Pat. No. 4,775,969, issued on Oct. 4, 1988, Osterlund discussed the emulation of a tape device with optical disk. These methods are not suitable for an optical write-once data card.

These patented inventions however do not provide relevant or an effective solution to enable a card-sized optical recording medium formed with write-once and rewritable data storage data tracks to carry out data update or error corrections on the recording medium. Therefore, a need still exists in the art to provide improved and new configuration and data access process to overcome such limitations.

### SUMMARY OF THE PRESENT INVENTION

Therefore, an aspect of this invention is to provide a method to produce a write once optical data card with a file system configuration and information stored in the card to enable random file accessing sessions of data and also the security to allow for only write once operation of the data access such that the data is not changeable once the data is recorded to this card.

Specifically, another aspect of this invention is to provide a data access method by implementing the last record location table, the record type location table, and dynamic file record type location tables to simplify and reduce the size of file directories and data access header length. With the implementation of these tables, secure and fast data file allocation for reading and writing of data can be conveniently carried out. The random file access sessions can be easily preformed on the written-once data track thus enables the implementation of data storage cards with sufficient data storage capacities for secure and convenient applications.

Another aspect of this invention is to manufacture a data storage card by burning off or etching off a portion of optical data storage disk to pattern a data storage area with either continuous spiral data tracks or discrete data arc segments depending on the shape of the data storage area. The patterned data storage area is cutoff and protected with a protective layer and attached to a data storage card that can be a standard credit card size of easy portability. The manufacturing processes are simplified and the production cost is reduced while the reliability of data card integrity and data stored there in are greatly improved.

Briefly, in a preferred embodiment, the present invention discloses a data-storage card that includes a data storage area includes a data track wherein the data storage area attached to the data storage card and the data storage area is patterned by burning-off or etching-off data storage tracks from a portion of a data storage surface on a data storage disk. In an exemplary embodiment, the data storage disk employed for patterning the data storage area by burning-off or etching-off the data storage tracks is an optical data storage disk to pattern the data storage area with an optical data track disposed thereon. In another exemplary embodiment, the data storage area further includes a circular data storage area. In another exemplary embodiment, the data storage area further includes a square data storage area. In another exemplary embodiment, the data storage area further includes a rectangular data storage area. In another exemplary embodiment, the data track in the data storage area further includes write-once data track for allowing only writing once onto the data track. In another exemplary embodiment, the data track in the data storage area further includes discontinuously discrete arc segments. In another exemplary embodiment, the data track in the data storage area further includes a continuous spiral data track. In another exemplary embodiment, the data storage area further includes a recording layer covered by a focus layer and supported by a dye layer and a reflective layer under the recording layer. In another exemplary embodiment, the data storage area is further covered by a protective layer larger than the data storage area whereby the protective layer surrounding the data storage area. In another exemplary embodiment, the data track in the data storage area further includes a last recorded table disposed at a beginning of the data track in the data storage area for providing a location on the data track of a latest updated data record. In another exemplary embodiment, the last recorded table further includes a data record length sufficient for at least one thousand times of additions to the last recoded table. In another exemplary embodiment, the data track further includes a record type location table written at an end of each recording session following a latest updated data record pointing to an end of the record type location table. In another exemplary embodiment, the record type location table further includes a security record for a user access validation and data related to skip-over locations on the data track for a controller to skip over a data access in the skip-over locations. In another exemplary embodiment, the data track further includes a dynamic file record type location table includes data for address of a space allocation record, an address of a file directory record and an address of a file entries record whereby information related to file locations, file size, file names, file creations dates and file directories are available for data access operations. In another exemplary embodiment, the data storage card further includes an off-center hole for engaging a spindle hub therein for rotating along the spindle hub and the data storage card further having a counter-weight attachment piece for balancing a rotation along the spindle hub engaged in the off-center hole. In another exemplary embodiment, the data storage card further includes an off-center hole for engaging a spindle hub therein for rotating along the spindle hub and the data storage card further having a counter-weight area having a less weight for balancing a rotation along the spindle hub engaged in the off-center hole

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 shows a data storage card with spiral optical data storage tracks.

FIG. 2 shows a burn-off shadowed area of a data storage card of FIG. 1.

FIG. 3, the remaining area for data storage has a square shape.

FIG. 4, the remaining area for data storage has a circular shape.

FIG. 5, the remaining area for data storage has a rectangular shape.

FIG. 6, shows a data card with square recording area FIG. 7, shows a data card with circular recording area FIG. 8, shows a data card with rectangular recording area.

FIG. 9 and FIG. 9A, show the data card with square recording area and offset center hole and counter balance weight area.

FIG. 10 and FIG. 10A, show the data card with circular recording area and offset center hole and counter balance weight area.

FIG. 11 and FIG. 11A, show the data card with rectangular recording area and offset center hole and counter balance weight area.

FIG. 12 is a cross sectional view for showing the layer structure of the data storage card.

FIG. 13 shows a last location table FIG. 14 shows the record type location table point to secure area and initial tables.

FIG. 15 shows a dynamic file record type location table.

FIG. 16 is a flowchart for showing the functional steps for writing data to the disk.

FIG. 17 is a flowchart for showing the functional steps for reading data from the disk.

### DETAILED DESCRIPTION OF THE PREFERRED EMBODIMENT

FIG. 1 shows an optical disk 100 that includes a spiral shaped data track 101 with a central hole 102 to function as a mounting hole for the purpose of locating and mounting to spindle hub. The data track 101 is formed as write-once data track that can only be written once and cannot be overwritten. FIG. 2 is an optical disk 100A with shadowed area 105A to be burned or etched off and data storage areas 110A for data storage respectively in these areas.

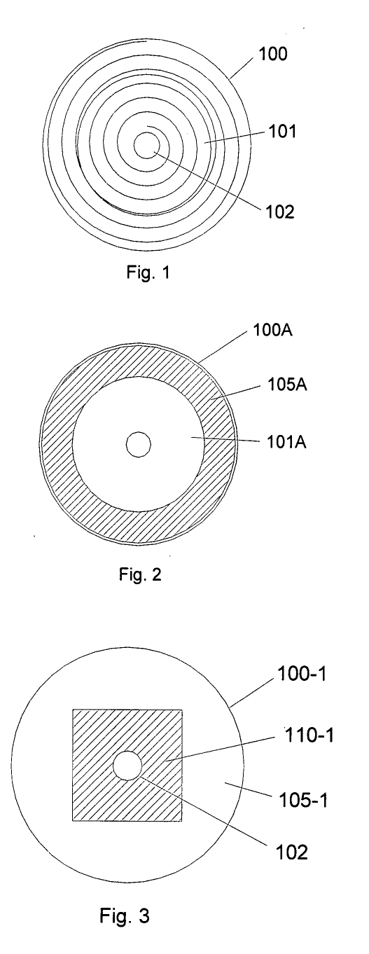

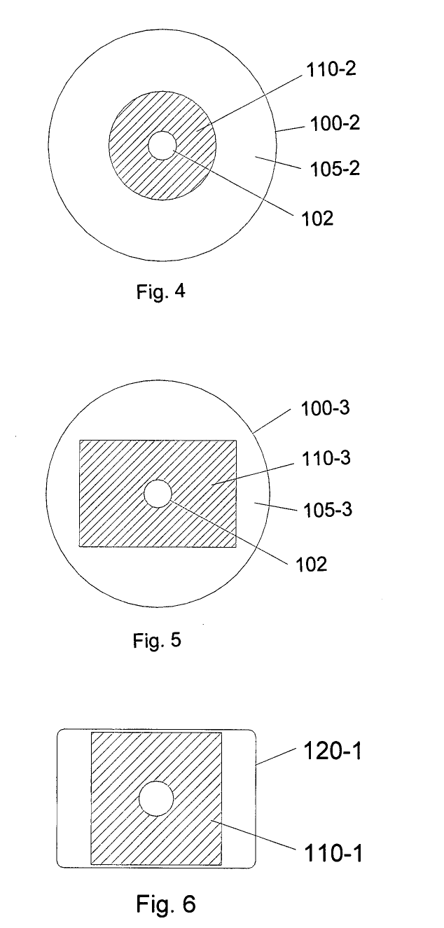

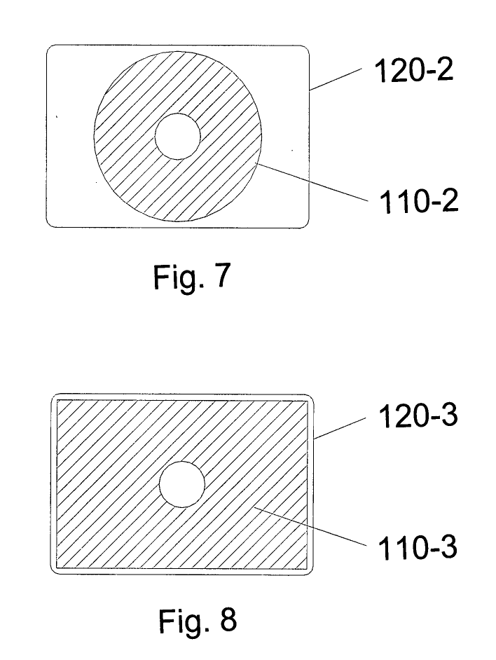

FIG. 3 is a top view to show the optical disk 100-1 having a hole 102 in the center with burned off or etched off areas 105-1 and square data storage area 110-1 that is kept as un-etched or not-burned off areas. FIG. 4 is a top view to show an alternate optical disk 100-2 having a hole 102 in the center with burned off or etched off areas 105-2 and circular-ring shaped data storage area 110-2 that is kept as un-etched or not-burned off areas. FIG. 5 is a top view to show the optical disk 100-3 having a hole 102 in the center with burned off or etched off areas 105-3 and rectangular data storage area 110-3 that is kept as un-etched or not-burned off areas. FIG. 6 is a data card 120-1 that supports and attaches the data storage area 110-1 of FIG. 3 thereon wherein the data storage area 110-1 is a cutoff piece from the optical disk 100-1 as shown in FIG. 3. FIG. 7 is a data card 120-2 that supports and attaches the data storage area 110-2 of FIG. 4 thereon wherein the data storage area 110-2 is a cutoff piece from the initial disk piece 100-2 as shown in FIG. 4. FIG. 8 is a data card 120-3 that supports and attaches the data storage area 110-3 of FIG. 5 thereon wherein the data storage area 110-3 is a cutoff piece from the initial disk piece 100-3.

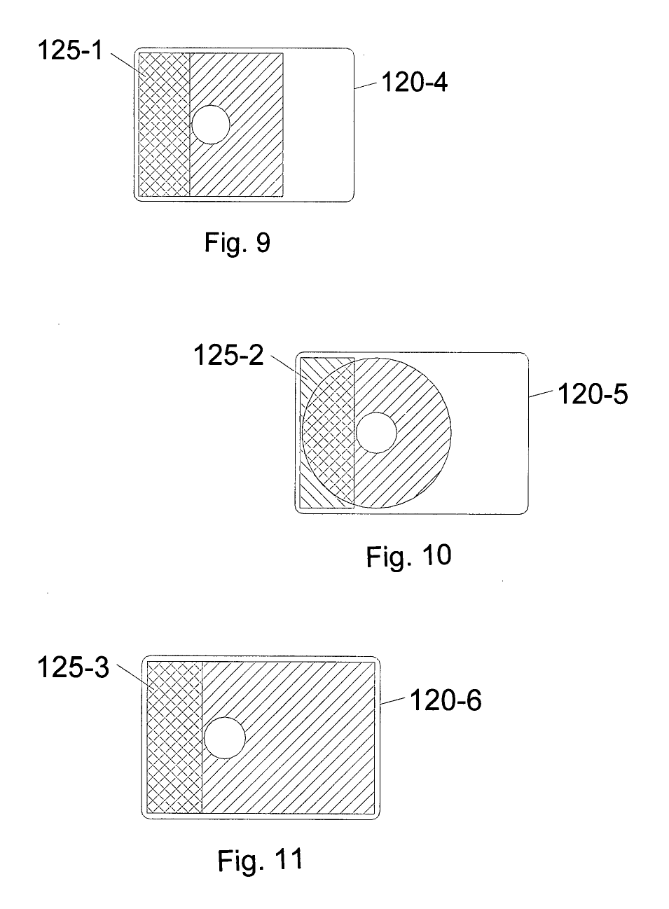

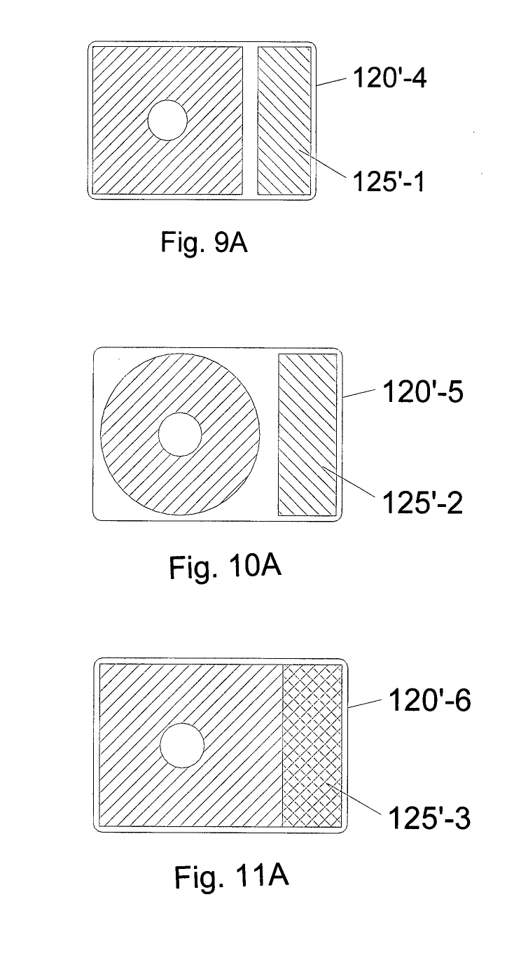

FIGS. 9 to 11 shows data cards 1204 to 120-6 as alternate embodiments for the data cards 120-1 to 120-3 respectively with a counter-weight attachment piece 125-1 to 125-3. These counter-weight attachment pieces are attached onto the data cards as to counter-balance the data cards 120-4 to 120-6 respectively during a rotational movement the center hole 102 is off-center. The counter-weight attachment pieces in each data card is attached to a side that has smaller area and less weight compared to the opposite side of the card from the center hole 102. With the counter weight attachments 125-1 to 125-3, when the data card is rotated along an axis perpendicular to the surface of the card located at the hole 102, the rotational movement is balanced with equal weights on both sides of the rotational axis. Alternatively, in FIG. 9A to 11A, the balance weights for rotation is achieved by removing a portion of the card, i.e., 125′-1 to 125′-3 respectively, from the side that has a greater area relative to the rotational hole 102 for mounting the rotation spindle.

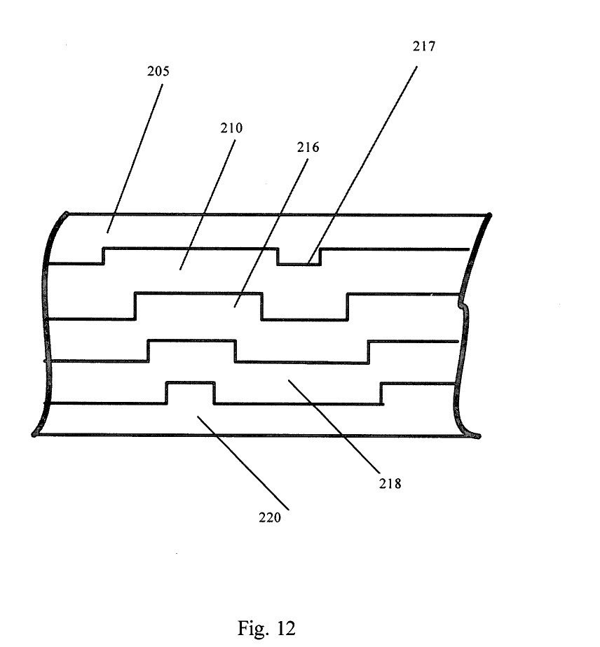

FIG. 12 shows a layer structure of an optical recording zone with the recording layer 210 covered by a focus layer 205 on the top and supported by a dye layer 216 and a reflective layer 218. The recording layer 210, the dye layer 216 and the reflective layer 218 have a smaller area than the protective layer 220 and are surrounded by the protective layer 220. The data track 217 is spiraled through out the recording area. The process of manufacturing includes a step of processing a polycarbonate disk coated with a protective layer 220 by spin coating a reflective layer 218, a dye layer 216 and a recording layer 210 thereon with spiral data track 217 disposed thereon. Then a focus layer 205 is coated on top of the recording layer 210. Both 220 and 205 are polycarbonate materials. A mask is applied onto the polycarbonate disk layers 216, 218, and 210 to laser burn, sputtering etch, or photolithographically etch the recording layers 210 and the reflective layers 218 from the unwanted areas. The remaining recording areas can be circular, square, rectangular or other pre-designated shapes. A stamping or cutting off the polycarbonate disk is applied to form the desirable shape and size.

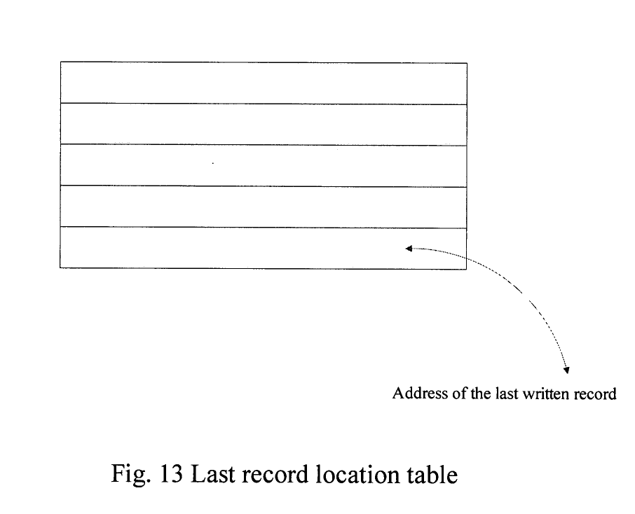

In order to manage and access to the data written onto the data tracks 101, directory and files are provided in the data tracks 101. FIG. 13 shows a last recorded location table that is typically located at the beginning of the track at a reserved segment of the data track to provide the location on the data track of the latest updated data record. The reserved segment provides sufficient large data storage space to allow for large number of data adding operations, e.g., 1000 additions. This table is updated at each recording session by appending revised or new data at the end of table. Since the data track 101 is a write-once data area, the data stored there cannot be overwritten. The table is therefore expanded during every update operation. The last record location table is optional. Since the data record written to the data track is sequential. A control program can perform a sequential or binary search to locate the last written record by checking whether there are data written to a particular point on the data track to determine the location of the last written record. The control program usually reads this last record table first when this table is available to determine the location of the latest data record written onto the data track. Otherwise, a search is performed to determine the last written record location.

FIG. 14 shows a record type location table that is written at the end of each recording session following the latest updated data record. The last record location table as shown in FIG. 12 points to the end of location of this table as a partition header area to identify this file system. The table includes data for the address of the copyright and security record for user access validation, the address of the space allocation record, the address of the file directory record and the address of the file entry record. The table also contains information relates to bad locations of this card for the controller to skip over the bad locations on the data track. A new table with all the old table data is created for each recording session including the file entry table.

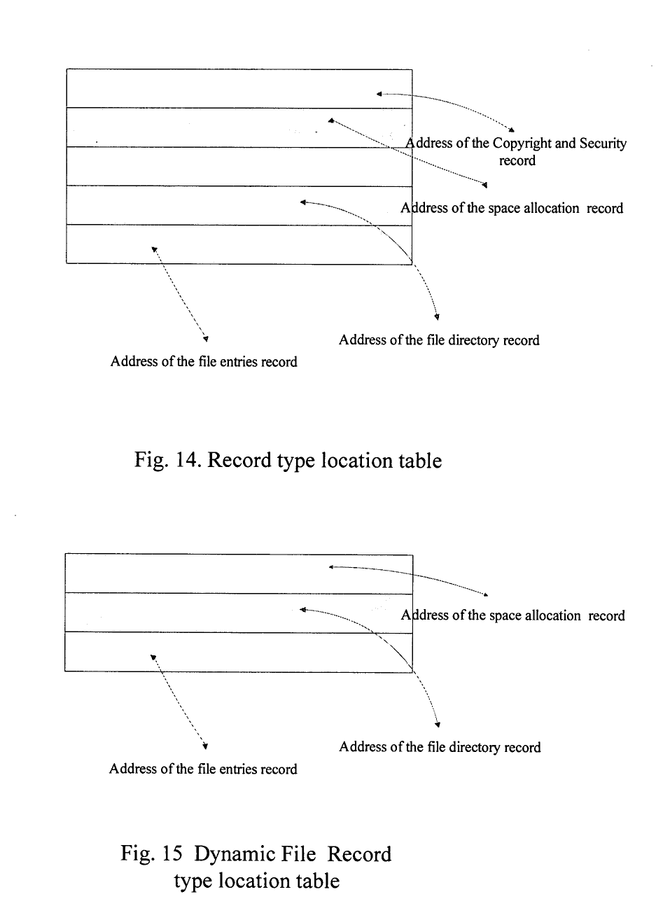

FIG. 15 shows a dynamic file record type location table that includes data for address of the space allocation record, the address of the file directory record and the address of the file entries record. The data shows where the file is located, the size of the file, the name of the file and other information such as creation data, etc. The table also provides information to point to a directory location that has information for files in that directory. This table is pointed through the data included in table shown in FIG. 13. A new table with all of the old table is created for each session and written at the recording session and written at the end of each update session including the entry table.

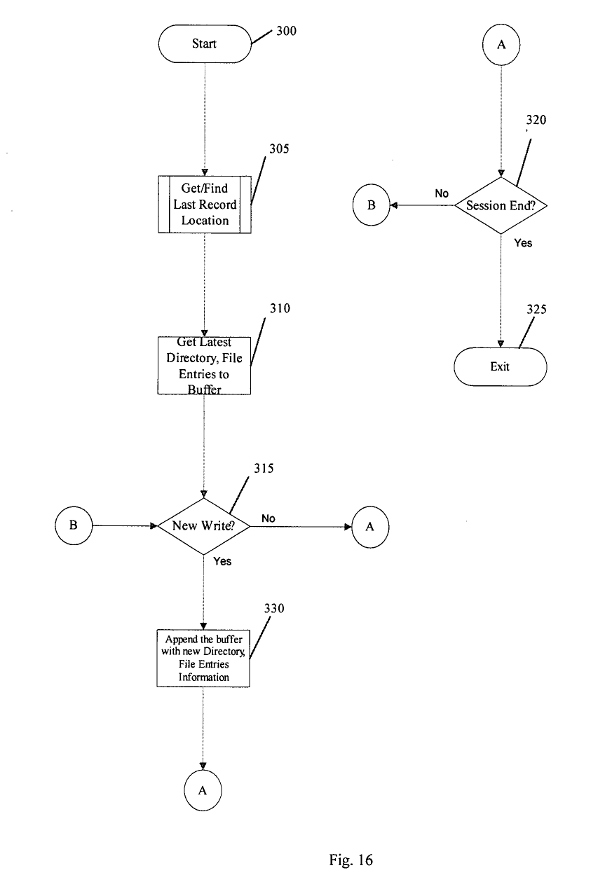

FIG. 16 is a flowchart to illustrate the operations for carrying out the file writing processes. The process begins (step 300) with a step of finding the location of the last record on the disk (step 305) followed by retrieving the data in the last record to determine the latest directory, file entries and buffer the retrieved information (step 310). Then a determination is made about whether to write new data onto the disk or not (step 315) and if a write session is not required (branch A), then a determination is made whether to end the session (step 320) and end the session (step 325) if it is determined that an end of session is intended. If an end of session is not an option (Branch B), then the process is loop back to a step for determining whether a new write session is intended (step 315). On the other hand, if it is determined that the process is directed to a new writing session, then new data for writing to the disk is obtained from the user followed by allocating spaces according to the data to be written to the disk and the information available in the buffer to write the data to the disk and appended with new directory information of the latest writing operation. Furthermore, file entry of the new data according to the new data written to the disk is also updated in the last record file (step 330). The process then proceeds to the step of determination of whether there is a requirement for ending the data writing session (step 320).

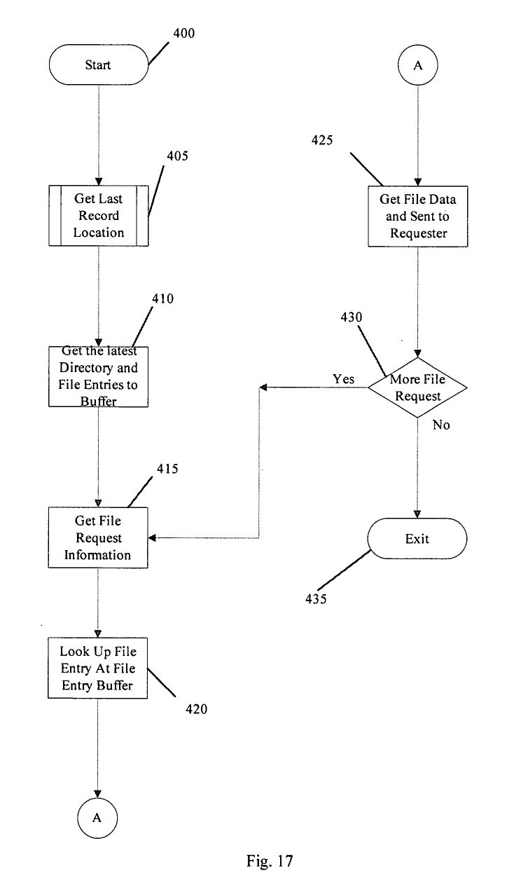

FIG. 17 is a flowchart to illustrate the operations for carrying out the file reading processes. The process begins (step 400) with a step of finding the location of the last record on the disk (step 405) followed by retrieving the data in the last record to determine the latest directory, file entries and buffer the retrieved information (step 410). Then the file information for reading the data is obtained from the user (step 415). Then a process is carried out to search the buffer directory, find the file location (Step 420) and read the file data back, send the data back to user (step 425). The file can be randomly accessed. Then a determination is made whether more reading operations are necessary (Step 430) and loop back to step 415 if more data file reading is required and end the reading session if the data reading operation is completed (step 435)

According to above descriptions, this invention further discloses a method for manufacturing a data-storage card. The method includes a step of forming an optical disk with data storage tracks for storing data there in; and patterning a data storage area by burning off or etching off a portion of the optical disk. In an exemplary embodiment, the method further includes a step of cutting off the data storage area from the optical disk and attaching the data storage area to the data storage card. In another exemplary embodiment, the step of patterning the data storage area further includes a step of patterning the data storage area as a circular data storage area. In another exemplary embodiment, the step of patterning the data storage area further includes a step of patterning the data storage area as a square data storage area. In another exemplary embodiment, the step of patterning the data storage area further includes a step of patterning the data storage area as a rectangular data storage area. In another exemplary embodiment, the step of forming the optical disk with data storage tracks further includes forming the data tracks in the optical disk as write-once data tracks for allowing only writing once onto the data tracks.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A data-storage card comprising:
a data storage area comprising a data track wherein said data storage area attached to said data storage card and said data storage area is patterned by burning-off or etching-off data storage tracks from a portion of a data storage surface on a data storage disk.

2. The data-storage card of claim 1 wherein:
said data storage disk employed for patterning said data storage area by burning-off or etching-off said data storage tracks is an optical data storage disk to pattern said data storage area with an optical data track disposed thereon.

3. The data-storage card of claim 1 wherein:
said data storage area further comprising a circular data storage area.

4. The data-storage card of claim 1 wherein:
said data storage area further comprising a square data storage area.

5. The data-storage card of claim 1 wherein:
said data storage area further comprising a rectangular data storage area.

6. The data-storage card of claim 1 wherein:
said data track in said data storage area further comprising write-once data track for allowing only writing once onto said data track.

7. The data-storage card of claim 1 wherein:
said data track in said data storage area further comprising discontinuously discrete arc segments.

8. The data-storage card of claim 1 wherein:
said data track in said data storage area further comprising a continuous spiral data track.

9. The data-storage card of claim 1 wherein:
said data storage area further comprising a recording layer covered by a focus layer and supported by a dye layer and a reflective layer under said recording layer.

10. The data-storage card of claim 9 wherein:
said data storage area is further covered by a protective layer larger than said data storage area whereby said protective layer surrounding said data storage area.

11. The data-storage card of claim 1 wherein:
said data track in said data storage area further comprising a last recorded table disposed at a beginning of said data track in said data storage area for providing a location on said data track of a latest updated data record.

12. The data-storage card of claim 11 wherein:
said last recorded table further comprising a data record length sufficient for at least one-thousand times of additions to said last recoded table.

13. The data-storage card of claim 1 wherein:
said data track further comprising a record type location table written at an end of each recording session following a latest updated data record pointing to an end of said record type location table.

14. The data-storage card of claim 13 wherein:
said record type location table further comprising a security record for a user access validation and data related to skip-over locations on said data track for a controller to skip over a data access in said skip-over locations.

15. The data-storage card of claim 1 wherein:
said data track further comprising a dynamic file record type location table includes data for address of a space allocation record, an address of a file directory record and an address of a file entries record whereby information related to file locations, file size, file names, file creations dates and file directories are available for data access operations.

16. The data-storage card of claim 1 further comprising:
an off-center hole for engaging a spindle hub therein for rotating along said spindle hub and said data storage card further having a counter-weight attachment piece for balancing a rotation along said spindle hub engaged in said off-center hole.

17. The data-storage card of claim 1 further comprising:
an off-center hole for engaging a spindle hub therein for rotating along said spindle hub and said data storage card further having a counter-weight area having a less weight for balancing a rotation along said spindle hub engaged in said off-center hole.

18. A method for manufacturing a data-storage card comprising:
forming an optical disk with data storage tracks for storing data there in; and
patterning a data storage area by burning off or etching off a portion of said optical disk.

19. The method of claim 18 further comprising:
cutting off said data storage area from said optical disk and attaching said data storage area to said data storage card.

20. The data-storage card of claim 18 wherein:
said step of patterning said data storage area further comprising a step of patterning said data storage area as a circular data storage area.

21. The data-storage card of claim 18 wherein:
said step of patterning said data storage area further comprising a step of patterning said data storage area as a square data storage area.

22. The data-storage card of claim 18 wherein:
said step of patterning said data storage area further comprising a step of patterning said data storage area as a rectangular data storage area.

23. The data-storage card of claim 18 wherein:
said step of forming said optical disk with data storage tracks further comprising forming said data tracks in said optical disk as write-once data tracks for allowing only writing once onto said data tracks.
